(19) United States
(12) Patent Application Publication
(10) Pub. No.: US 2004/0217563 A1
(43) Pub. Date: Nov. 4, 2004

(54) Rescue sled

(76) Inventor: Kenneth E. Butts JR., Stevensville, MD (US)

Correspondence Address: LAW OFFICE OF LAWRENCE E LAUBSCHER, JR, 1160 SPA RD, SUITE 2B, ANNAPOLIS, MD, 21403, US

(21) Appl. No.: 10/424,450

(22) Filed: Apr. 29, 2003

(51) Int. Cl. B62B 9/04

(52) U.S. Cl. 280/18

(57) ABSTRACT

A portable rescue sled includes an inflatable base covered with netting suitable to rescue victims who have fallen through the ice of a frozen pond. The base is normally coiled in a retracted deflated condition. When positioned at the edge of a lake or pond, air from a compressed air tank on the sled is used to inflate the base which uncoils toward the victim into an extended position. A portion of the netting extends beyond the base and is used by the victim to climb onto the sled which may then be pulled to safety.

### BACKGROUND OF THE INVENTION

Every winter there are numerous occurrences of people or animals trying to cross a frozen river or pond and falling through thin ice into the frigid water below. Rescuing these individuals or animals is particularly dangerous because the rescuer may also fall through the ice and thus need rescuing as well. Because hypothermia develops very quickly, there is a need to rescue individuals without delay. The present invention relates to a portable extendable rescue sled which is designed to float on water so that an individual who is in despair can climb onto the sled and be pulled to safety.

### BRIEF DESCRIPTION OF THE PRIOR ART

The most common technique for rescuing people who have fallen through ice or into an icy river is to stand on shore and throw them a rope. This techniques requires both an accurate toss and the ability of the victim to hold onto the rope with enough strength to be pulled to safety. However, it is difficult for the victim to hold the rope or a life ring, particularly if hypothermia has begun. Moreover, as the victim is pulled from the area where the ice has broken, the weight of the victim often causes the surrounding ice to break as well, further hampering the rescue effort. Another drawback of the conventional rope technique is that it is not possible for the rescuer to approach the victim without risking danger of the rescuer falling through the ice as well.

Inflatable water craft for survival applications are known in the patented prior art as evidenced by U.S. Pat. No. 6,066,016. Also known in the art is a collapsible inflatable device which can be used as a toboggan as shown by U.S. Pat. No. 4,389,961.

While the prior devices operate satisfactorily, they are not suitable for quick and easy deployment for use in rescuing a victim who has fallen through ice into a frigid body of water. The present invention was developed in order to overcome these drawbacks by providing an inexpensive rescue sled which can be used to rescue such victims.

### SUMMARY OF THE INVENTION

The present invention relates to a rescue sled including an inflatable base operable between an extended inflated condition and a retracted deflated condition. Netting is connected with the base and extends across the upper surface. The netting has a lattice configuration and includes a portion which extends beyond the far end of the base when the base is in the extended condition. The portion of the netting which is connected with the base has a slightly smaller length than the length of the base so that when the base is deflated, the netting causes the base to coil.

On top of the base upper surface is a longitudinal support between the netting and the base which serves to space the netting from the base.

A source of compressed air such as a tank is mounted on the base at the near end. The tank is used to quickly inflate the base to its extended position via a valve located in the near end of the base. A lateral pocket or sleeve is also provided in the near end of the base and a rigid rod is arranged in the pocket to support the base and tank when the base is in the retracted position. A lead rope is preferably connected with the rod.

A VELCRO fastener is provided at the far end of the base in order to connect a further base to the sled in order to extend the length of the sled as necessary.

When air is delivered to the base from the tank of compressed air, the base uncoils and extends longitudinally. Once extended, the sled may be positioned across a layer of ice or a body of water to a victim therein. The victim may grasp the netting which extends beyond the base and climb onto the sled. The sled operator then pulls the sled across the ice or water to bring the victim to safety.

### BRIEF DESCRIPTION OF THE DRAWINGS

Other objects and advantages of the invention will become apparent from a study of the following specification when viewed in the light of the accompanying drawing, in which:

FIG. 1 is a perspective drawing of the rescue sled according to the invention;

FIG. 2 is a top plan view of the sled of FIG. 1;

FIG. 3 is a sectional view of the sled taken along line 3-3 of FIG. 2;

FIGS. 4A-4C are side plane views, respectively, of the sled as it progresses from its retracted to extended conditions;

FIG. 5 is a partial sectional view of the sled taken along line 5-5 of FIG. 2;

FIG. 6 is a partial sectional view of the sled taken along line 6-6 of FIG. 2;

FIG. 7 is a partial sectional view of the sled taken along line 7-7 of FIG. 2;

FIG. 8 is a top view of the section shown in FIG. 7;

FIG. 9 is a partial sectional view of the sled taken along line 9-9 of FIG. 2;

FIG. 10 is a top view of the section shown in FIG. 9; and

FIG. 11 is a top plan view of a fastener used to connect adjoining sled portions.

### DESCRIPTION OF THE PREFERRED EMBODIMENT

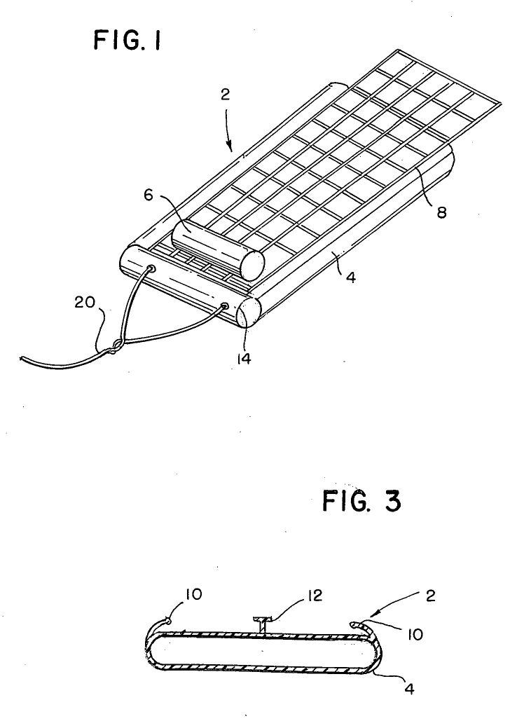

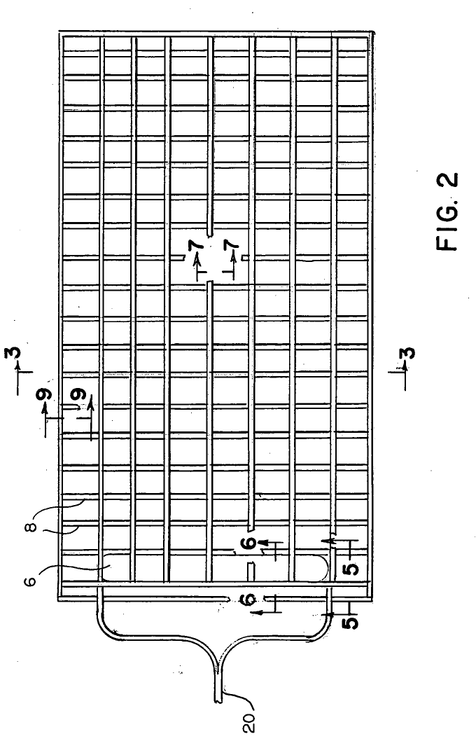

Referring first to FIGS. 1-3, the rescue sled 2 according to the invention will be described. The sled includes an inflatable base 4 which is preferably formed of synthetic plastic material and has an elongated configuration when extended as shown in FIGS. 1 and 2.

In order to inflate the base, a tank 6 of compressed air is mounted on the upper surface of the base as shown in FIGS. 1, 2, and 6. A hose (not shown) from the tank 6 to the base 4 is provided to deliver air under pressure to the base in order to inflate it. As the base inflates, it uncoils to an extended position as will be discussed in greater detail below. A release valve (not shown) in the base allows air to leave the interior of the base so that the base deflates and retracts.

Netting 8 extends across the top surface of the inflatable base. The netting has a lattice configuration and is connected with the base along the upper perimeter thereof. A preferred connection is shown in FIGS. 9 and 10. At the upper edge of the base 4 and extending at least along the sides and preferably around the periphery thereof is a flap 10. The outermost strand of the netting is stitched to the flap as shown in FIG. 10. In addition, the ends of cross-portions 8a of the netting are stitched to the flap as well. The netting is formed of any strong flexible material such as nylon or polyethylene.

Preferably, the netting 8 is supported above the upper surface of the base in spaced relation relative to the base by at least one longitudinal support member 12 which is arranged centrally of the base. The support member provides a crowning effect to the netting as shown in FIG. 3, wherein the longitudinal central portion of the netting is higher than the side edges. If desired, the netting can be stitched to the top of the support member as shown in FIG. 8 in order to keep the netting in place. The support is formed of a flexible material so that it can be coiled up with the base when the base returns to its retracted condition.

At the far end of the base opposite the end having the compressed air tank mounted thereof, the netting 8 extends beyond the base for a suitable distance such as 3-4 feet. The extended portion acts as a ladder and allows the victim to climb onto the sled as will be developed below.

At the near end of the base, there is provided a laterally extending sleeve 14 within which is arranged a rod 16 as shown in FIG. 5. The rod provides support for the end of the sled, base, and tank. A strap portion 18 of the sleeve is connected with the bottom of the sled base 4 after the rod is installed in order to hold it in place. Extending forwardly of the sled is a lead line or rope 20 which can be used to pull the sled or to anchor the sled such as by securing the far end of the rope to a fixed object such as a tree.

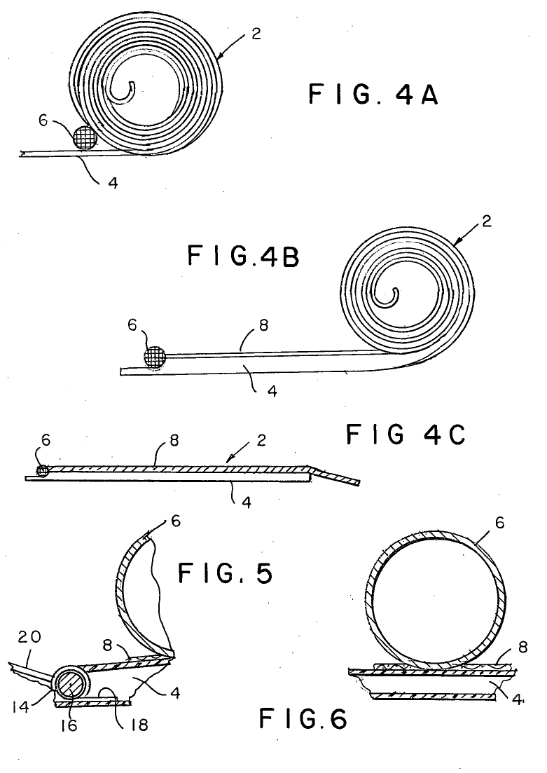

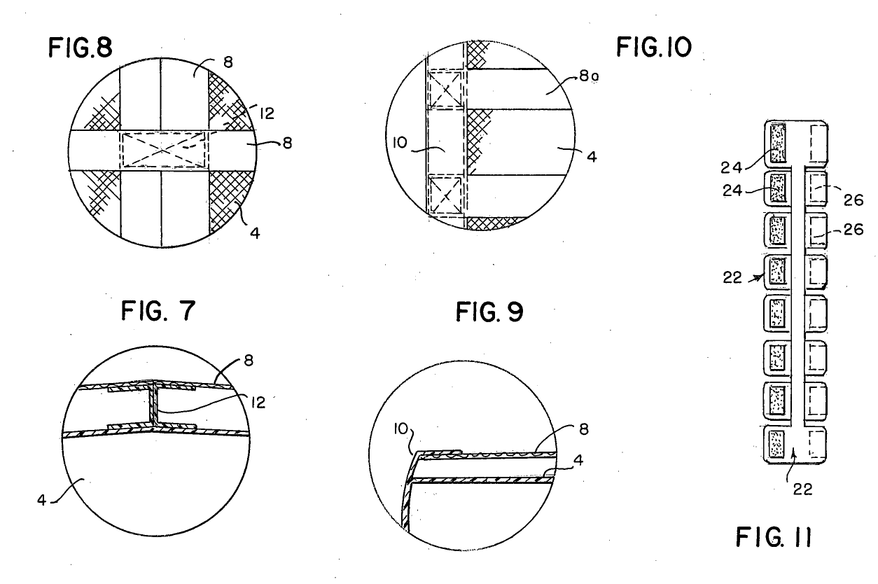

The operation of the rescue sled according to the invention will now be described. The normal condition of the sled is shown in FIG. 4A wherein the base is deflated and coiled up against the tank of compressed air. This makes the sled easily transportable to a location where a victim is to be rescued. At the location, the sled is set on firm ground and the lead rope can be secured to a fixture. Air from the tank is then delivered to the base which begins to inflate and uncoil as shown in FIG. 4B. Upon continued inflation, the base is fully extended with the netting arranged across the top surface as shown in FIG. 4C. A portion of the netting extends beyond the far end of the base and provides a ladder-like portion for the victim to use to climb up onto the upper surface of the base. Because the netting is supported above the base surface, it affords hand and foot holds for the victim to propel himself onto the sled.

If the sled is used on a frozen body of water, it extends across the ice to a hole therein formed by the victim. With the victim on top of the sled, the weight distribution across the sled base is normally sufficient to prevent the ice beneath the sled from breaking further. However, if the ice is too thin to support the sled and victim, the sled base has sufficient buoyancy to float on the water and the sled and victim can be safely pulled to shore.

If the victim is comatose or suffering from acute hypothermia or is an animal, the rescuer can crawl out on the sled to the victim and pull the victim or animal onto the sled which can then be pulled to safety.

Because the sled is buoyant, it can be used to rescue victims from any body of water. That is, it is not limited to use on frozen bodies of water.

The base can be made in any convenient width or length. A standard length for example could be 50 feet so that the sled can reach far out onto the body of water. If even more length is needed, a second base with netting can be connected with a first base via any suitable fastener such as VELCRO strap 22 as shown in FIG. 11. The strap includes pile 24 and hook 26 portions which are adapted to make with complementary portions arranged along the ends of adjacent bases.

While the preferred forms and embodiments of the invention have been illustrated and described, it will be apparent to those of ordinary skill in the art that various changes and modification may be made without deviating from the inventive concepts set forth above.

What is claimed is:

1. A portable sled for supporting individuals, comprising:
(a) an inflatable base having near and far ends and operable between an extended inflated condition and a retracted deflated condition; and
(b) netting connected with said base and extending across an upper surface thereof, said netting having a lattice configuration and including a portion which extends beyond said far end of said base when said base is in its extended condition, whereby when said base is in its extended inflated condition, the sled may be used to rescue an individual from a body of water.

2. A portable sled as defined in claim 1, and further comprising means for supporting said netting above said base upper surface.

3. A portable sled as defined in claim 1, and further comprising a tank of compressed air connected with said near end of said base.

4. A portable sled as defined in claim 3, wherein said base contains a lateral pocket at said near end for receiving a lateral rod for supporting said base and said tank when said base is in its retracted position.

5. A portable sled as defined in claim 1, and further comprising a connecting device connected with said base far end for removably connecting a second base to the sled to further extend the sled in a longitudinal direction.
